(19) United States
(12) Patent Application Publication
(10) Pub. No.: US 2024/0217776 A1
(43) Pub. Date: Jul. 4, 2024

(54) METHOD FOR DETERMINING TYPE OF ELEVATOR, ELEVATOR MONITORING SYSTEM, AND ELEVATOR

(71) Applicant: KONE Corporation, Helsinki (FI)

(72) Inventors: Mari Zakrzewski, Helsinki (FI); Jaakko Huhtala, Helsinki (FI); Matti Mustonen, Helsinki (FI); Olli Eloranta, Helsinki (FI)

(73) Assignee: KONE Corporation, Helsinki (FI)

(21) Appl. No.: 18/602,837

(22) Filed: Mar. 12, 2024

Related U.S. Application Data
(63) Continuation of application No. PCT/EP2021/080140, filed on Oct. 29, 2021.

(51) Int. Cl. B66B 5/00; B66B 1/34; B66B 3/00

(52) U.S. Cl. CPC B66B 5/0018; B66B 1/3492; B66B 3/002

(57) ABSTRACT

A method for determining a type of elevator, an elevator monitoring system, and an elevator are disclosed. The method includes obtaining data related to movement and/or position of a component of a hoisting system, such as an elevator car, of the elevator, determining from the data at least one characteristic value related to the movement and/or position, and determining the type based on pre-defined elevator types of an elevator type classification and the characteristic value.

### FIELD OF THE INVENTION

The present invention relates in general to elevators. In particular, however not exclusively, the present invention concerns methods and systems for improving monitoring, such as condition and/or performance, of elevators.

### BACKGROUND

There are various ways to provide movement of an elevator car in an elevator. Depending on the type of the elevator, the elevator car may accelerate and decelerate slightly differently. This may depend, for example, whether the elevator is a traditional roped or hydraulic elevator, as well as on the drive system properties and other technical features.

The reliability of elevator equipment data may be poor especially. For example, the elevator might be marked as a traditional rope elevator while in fact it is a hydraulic elevator. The elevator type has been found out by either relying on the metadata, asking maintenance personnel or checking the elevator during other maintenance or installations. The maintenance personnel could provide more accurate information of the elevator type, however, requires manual labor and is thus costly. The poor data quality prevents the use of elevator type information when developing analytics solutions for monitoring the condition of the elevator since without the accurate information about the type of the elevator, wrong conclusions can be made of the condition.

### SUMMARY

An objective of the present invention is to provide a method for determining a type of elevator, an elevator monitoring system, and an elevator. Another objective of the present invention is that the method, the elevator monitoring system, and the elevator provide efficient way to determine the type of elevator and, thereby enable more accurate analytics and diagnostic to be made regarding the operation of the elevator.

The objectives of the invention are reached by a method for determining a type of elevator, an elevator monitoring system, and an elevator as defined by the respective independent claims.

According to a first aspect, a method for determining a type of elevator is provided. The method comprises obtaining data related to movement and/or position of a component of a hoisting system, such as of an elevator car, of the elevator, and determining from the data at least one characteristic value related to the movement and/or position. The method further comprises determining the type based on pre-defined elevator types of an elevator type classification and the characteristic value.

The component of the hoisting system may be one of the following: the elevator car, a hoisting rope, a traction sheave or pulley, an elevator motor, or basically any part or device of the elevator based on monitoring of which, information may be obtained regarding characteristics of the movement and/or position of the hoisting function and/or system of the elevator.

In addition, the method may, preferably, comprise adapting at least one parameter of an elevator monitoring system of the elevator based on the determined type of elevator.

The determination of the type may be based on comparison of information in the obtained data related to an event to pre-defined information in the elevator type classification for the same event, such as related to moving the elevator car between landings. Thus, the data may be obtained specifically related to some pre-defined event or functionality of the hoisting system and/or the elevator. The pre-defined event or functionality may be, for example, said moving of the elevator car between landings. However, it can alternatively relate to some other event or functionality.

In various embodiments, the elevator monitoring system may be configured to receive further data related to movement and/or position of the component of the hoisting system, and compare information obtained from the further data to at least one criterion defined based on the adapted at least one parameter so as to monitor a condition and/or performance of the elevator.

Alternatively or in addition, the method may comprise generating, by the elevator monitoring system, an alert related to a reduction in the condition and/or performance determined based on the comparison.

Furthermore, the movement and/or position may include at least one selected from the group consisting of: absolute or relative position, speed, velocity, acceleration, deceleration, jerk. The jerk refers herein to the rate at which the component's, such as the elevator car's, acceleration or deceleration changes with respect to time.

In various embodiments, the obtaining may comprise determining the data by at least one selected from the group consisting of: an accelerometer, an air pressure sensor, a speed sensor, a velocity sensor, an absolute or relative position measurement sensor, a magnetometer, an optical sensor, such as a camera, a magnetic tape reader, a laser distance measurement, a radar, a sound based distance measurement device, such as based on ultrasound, an incremental encoder, such as a low pulse incremental encoder.

The elevator type classification may include reference characteristic value or values for the at least one characteristic value in relation to the pre-defined elevator types. Alternatively or in addition, the predefined elevator types may include at least two selected from the group consisting of: roped elevator, hydraulic elevator, linear motor elevator.

In many embodiments, the reference characteristic value or values may be utilized so that the measured characteristic value can be compared to the pre-defined reference characteristic value of pre-defined elevator types. Then the measured characteristic value may be matched with the best fitting reference characteristic value, and thereby determining the elevator type associated to that reference characteristic value.

In various embodiments, the predefined elevator types may be defined by at least two elevator characteristics. Optionally, the at least two elevator characteristics may include movement means and movement controlling means.

The movement means may include at least roped type and hydraulic type. Alternatively or in addition, the movement controlling means may include at least one selected from variable speed drive type, direct online type (for example, including a motor directly connected to a supply and connected to the elevator car drive system by a gear or the like), and hydraulic type. Furthermore, alternatively or in addition, the movement controlling means may include sub-types as defined in the following: the variable speed drive sub-types being scalar control, such as an open-loop scalar control without speed measurement/estimation, and vector control, such as field-oriented control or direct torque control, the direct online sub-types being one-speed or two-speed.

In various embodiments, the elevator type classification may include reference characteristic value or values for at least one selected from the group consisting of: duration and/or amplitude of jerk, duration and/or amplitude of acceleration/deceleration, duration and/or amplitude of velocity in steady speed area (that is, the speed of the component of the hoisting system once it has been accelerated to a speed corresponding to its setpoint speed), speed variation in the steady speed area between consecutive rides between same landings and direction, number and shape of deceleration phases, similarity of drive curves in opposite directions (typically upwards and downwards in elevators with vertical movement), elevator car vibrations during ride phases, such as speed ripple, or values calculated from the Fourier spectrum of acceleration curve. Regarding the steady speed area, speed at said area is affected, at least in some elevator types, by, for example, the loading of the elevator car. There may also be other factors affecting the speed at said area, for example, depending on the control algorithm/system. Example of this is the stator frequency in the case of the open-loop scalar control. Thus, the steady speed area, and particularly the characteristics of the speed at said area, can be utilized in determining of the type of the elevator.

In various embodiments, alternatively or in addition, at least one characteristic value relates to at least one selected from the group consisting of: duration and/or amplitude of jerk, duration and/or amplitude of acceleration/deceleration, duration and/or amplitude of velocity in steady speed area, speed variation in the steady speed area between consecutive rides between same landings and direction, number and shape of deceleration phases, similarity of drive curves in opposite directions (typically upwards and downwards in elevators with vertical movement), elevator car vibrations during ride phases, such as speed ripple, or values calculated from the Fourier spectrum of acceleration curve.

According to a second aspect, an elevator monitoring system is provided. The elevator monitoring system comprises a processing unit and a memory, such as a non-transitory memory medium. The elevator monitoring system is configured to execute steps of the method in accordance with the first aspect as described herein.

The elevator monitoring system may comprise or be connected to at least one selected from the group consisting of: an accelerometer, an air pressure sensor, a speed sensor, a velocity sensor, an absolute or relative position measurement sensor, a magnetometer, an optical sensor, such as a camera, a magnetic tape reader, a laser distance measurement, a radar, a sound based distance measurement device, such as based on ultrasound, an incremental encoder, such as a low pulse incremental encoder.

According to a third aspect, an elevator is provided. The elevator comprises an elevator car movable in an elevator shaft, movement means or a movement generation unit, such as comprising a motor, for providing the movement of the elevator car, and movement controlling means or a motion control unit, such as comprising a frequency converter, for controlling the movement. The elevator also comprises the elevator monitoring system in accordance with the second aspect as described herein.

The present invention provides a method for determining a type of elevator, an elevator monitoring system, and an elevator. The present invention provides advantages over known solutions in that the elevator type classification allows the elevator monitoring system to be tuned per each elevator type to perform better, and thus enables more accurate decisions to be made regarding service needs.

For example, hydraulic elevators have larger vibrations during the operation. With wrong or non-optimized monitoring system, higher than normal vibrations may trigger a need for service for hydraulic elevators, even if in reality the condition of the elevator is in an acceptable level. With the type classification as described herein, the monitoring system can be made to allow larger vibrations for hydraulic elevators or even to be turned off for hydraulics when considering vibrations only.

Furthermore, certain monitoring algorithms fail for certain types of elevators. With the elevator type information included, the algorithms can tested and debugged with respect to their performance separately for each elevator type. Different parameter configurations could be used for different types of elevators to improve the performance of the algorithms.

Various other advantages will become clear to a skilled person based on the following detailed description.

The expression “a number of” may herein refer to any positive integer starting from one (1), that is, being at least one or more than one.

The expression “a plurality of” may refer to any positive integer starting from two (2), that is being at least two, three, four, five, or more.

The terms “first”, “second” and “third” are herein used to distinguish one element from other element, and not to specially prioritize or order them, if not otherwise explicitly stated.

The exemplary embodiments of the present invention presented herein are not to be interpreted to pose limitations to the applicability of the appended claims. The verb “to comprise” is used herein as an open limitation that does not exclude the existence of also unrecited features. The features recited in depending claims are mutually freely combinable unless otherwise explicitly stated.

The novel features which are considered as characteristic of the present invention are set forth in particular in the appended claims. The present invention itself, however, both as to its construction and its method of operation, together with additional objectives and advantages thereof, will be best understood from the following description of specific embodiments when read in connection with the accompanying drawings.

### BRIEF DESCRIPTION OF FIGURES

Some embodiments of the invention are illustrated by way of example, and not by way of limitation, in the figures of the accompanying drawings.

FIG. 1 shows a flow diagram of a method in accordance with an embodiment.

FIGS. 2A and 2B illustrate schematically elevator monitoring systems according to some embodiments.

FIGS. 3A-3D illustrates graphs related to operation of elevators with different types in accordance with some embodiments.

FIG. 4 illustrates an elevator according to an embodiment.

FIG. 5 illustrates a monitoring unit or system according to an embodiment.

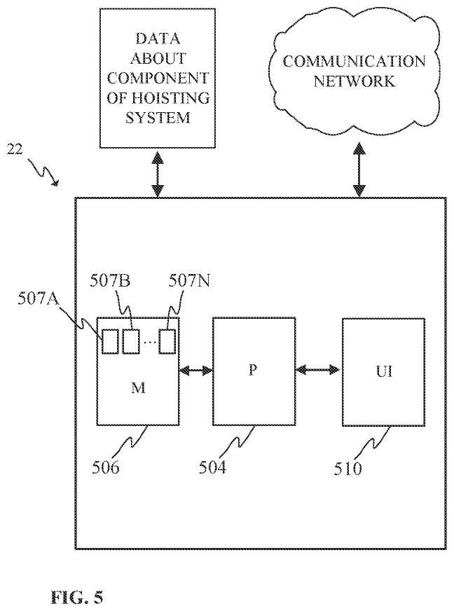

### DETAILED DESCRIPTION OF SOME EMBODIMENTS

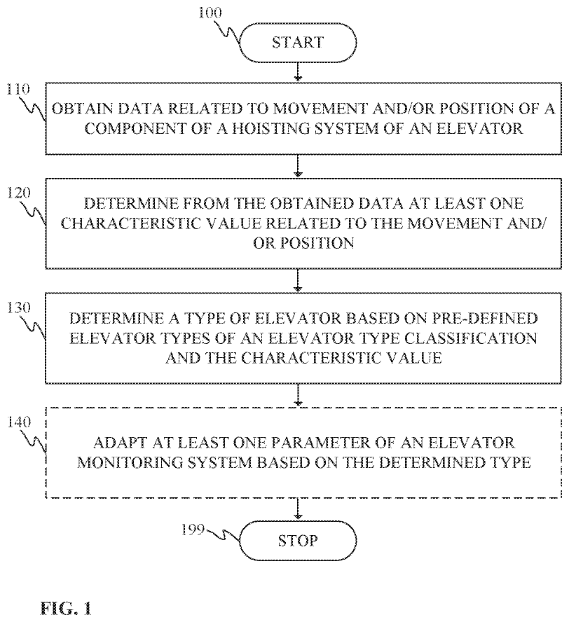

FIG. 1 shows a flow diagram of a method in accordance with an embodiment. Item 100 refers to a start-up phase of the method. Suitable equipment and components are obtained and (sub-)systems assembled and configured for operation. This may, in some embodiments, arranging a monitoring device and/or sensors so that information about the operation of the elevator can be obtained, determined and/or measured.

Item 110 refers to obtaining data related to movement and/or position of a component, such as an elevator car, of a hoisting system of the elevator.

Item 120 refers to determining from the data at least one characteristic value related to the movement and/or position.

Item 130 refers to determining the type based on pre-defined elevator types of an elevator type classification and the characteristic value.

An optional item 140 (shown with dashed lines indicating the optionality) refers to comprising adapting at least one parameter of an elevator monitoring system of the elevator based on the determined type of elevator.

Method execution may be stopped at item 199.

In various embodiments, the elevator monitoring system may be configured to receive further data related to movement and/or position of the component, such as the elevator car, and compare information obtained from the further data to at least one criterion defined based on the adapted at least one parameter so as to monitor a condition and/or performance of the elevator. Furthermore, in some embodiments, the method may comprise generating, by the elevator monitoring system, an alert related to a reduction in the condition and/or performance determined based on the comparison.

The determination of the type of elevator may be based on comparison of information in the obtained data, such as the at least one characteristic value, related to an event to pre-defined information, such as corresponding pre-defined reference characteristic value, in the elevator type classification for the same event, such as related to moving the elevator car between landings. Thus, the data may be obtained specifically related to some pre-defined event or functionality of the hoisting system and/or the elevator. The pre-defined event or functionality may be, for example, said moving of the elevator car between landings. However, it can alternatively relate to some other event or functionality.

The determined type of elevator may, thus, be utilized to change the operation of the monitoring system so that unnecessary alerts may be avoided since the elevator type and its operational characteristics are taken into account in the analytics performed regarding the operation of the elevator, such as with respect to condition and/or performance thereof.

In at least some embodiments of the method, the movement and/or position may include at least one selected from the group consisting of: absolute or relative position, air pressure, speed, velocity, acceleration, deceleration, jerk. Furthermore, the obtaining may comprise determining the data by at least one selected from the group consisting of: an accelerometer, an air pressure sensor, a speed sensor, a velocity sensor, an absolute or relative position measurement sensor, a magnetometer, an optical sensor, such as a camera, a magnetic tape reader, a laser distance measurement, a radar, a sound based distance measurement device, such as based on ultrasound, an incremental encoder, such as a low pulse incremental encoder.

In various embodiments, the accelerometer data may be utilized as acceleration/deceleration, or it may be utilized by integrating it to determine speed or position. Alternatively or in addition, data of the air pressure sensor may be utilized to determine height of the elevator shaft, for instance. The magnetometer may, alternatively or in addition, be utilized determined movement related information, such as speed, by the position (and/or the change thereof) information based on magnetic map of the elevator shaft.

In various embodiments, the elevator type classification may include reference characteristic value or values for the at least one characteristic value in relation to the pre-defined elevator types.

The predefined elevator types may include at least two selected from the group consisting of: a roped elevator (such as comprising a rotary electric motor for rotating a sheave arranged in connection with the rope), a hydraulic elevator, a linear motor elevator.

In various embodiments, the predefined elevator types may be defined by at least two, or even more, elevator characteristics. The elevator characteristics may include at least one, or two, of the following: movement means and movement controlling means. In some embodiments, the movement means may include at least the roped type and the hydraulic type. Alternatively or in addition, the movement controlling means may include at least one selected from variable speed drive type, direct online type, and hydraulic type.

In some embodiments, the movement controlling means, or types thereof, may include sub-types. In an embodiment, the sub-types may be as follows: the variable speed drive sub-types may include or consist of scalar control, preferably, an open-loop scalar control without speed measurement/estimation, and vector control, such as field-oriented control or direct torque control. Alternatively or in addition, the direct online sub-types may include or consist of one-speed or two-speed.

The method may include in various embodiments thereof the elevator type classification including reference characteristic value or values for at least one selected from the group consisting of: a duration and/or an amplitude of jerk, a duration and/or an amplitude of acceleration/deceleration, a duration and/or an amplitude of velocity in steady speed area, speed variation in the steady speed area between consecutive rides between same landings and direction, a number and a shape of deceleration phases (the shape referring to deceleration curves as a function of time), similarity of drive curves in opposite directions, elevator car vibrations during ride phases, such as speed ripple, or values calculated from the Fourier spectrum, or based on another method of determining frequency content, of an acceleration curve.

The method may, thus, in various embodiments thereof the at least one characteristic value relating, optionally correspondingly relative to the reference characteristic value or values of the elevator type classification, to at least one selected from the group consisting of: a duration and/or an amplitude of jerk, a duration and/or an amplitude of acceleration/deceleration, a duration and/or an amplitude of velocity in steady speed area, speed variation in the steady speed area between consecutive rides between same landings and direction (for example, as the speed with nominal frequency may depend on the elevator car load with scalar controlled induction motor drive due to slip caused by the load), a number and a shape (the shape referring to deceleration curves as a function of time) of deceleration phases, similarity of drive curves in opposite directions, elevator car vibrations during ride phases, such as speed ripple, or values calculated from the Fourier spectrum, or based on another method of determining frequency content, of acceleration curve.

In various embodiments, the method described herein may be implemented, or executed, by an elevator monitoring system 20. The elevator monitoring system 20 comprises at least a processing unit and a memory, such as a non-transitory memory medium. Furthermore, the elevator monitoring system 20 may, preferably, also comprise communication means or at least one communication device for providing communication connection between at least two components/units of the elevator monitoring system 20, and/or communication between the elevator monitoring system 20 and an external device or database, such as over the internet/public communication network.

Regarding the elevator monitoring system 20, the components/units thereof may each be at the site/location of the elevator 200, or they can be partially at the site/location and partially external components/units which are in communication connection with the components/units at the site.

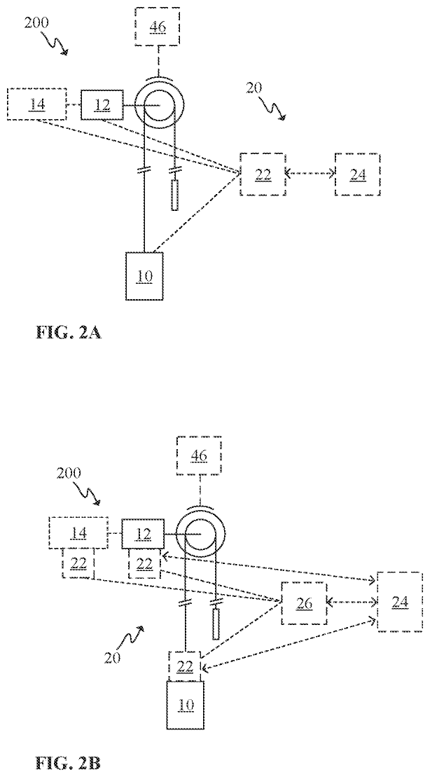

FIGS. 2A and 2B illustrate schematically elevator monitoring systems 20 according to some embodiments. FIG. 2A illustrates an embodiment in which a monitoring unit 22 of the system 20 is arranged to at least receive data from one or several components of the elevator 200. For example, the monitoring unit 22 may be arranged to receive at least data related to movement and/or position of the component, such as the elevator car 10, the elevator motor 12, and/or the traction sheave or pulley 16, or the like, of the hoisting system of the elevator 200. Thus, the monitoring unit 22 may be connected to an accelerometer, an air pressure sensor, a speed sensor, a velocity sensor, an absolute or relative position measurement sensor, a magnetometer, an optical sensor, such as a camera, a magnetic tape reader, a laser distance measurement, a radar, a sound based distance measurement device, such as based on ultrasound, and/or an incremental encoder, such as a low pulse incremental encoder, of the elevator 200.

The data may be obtained from sensor(s) or device(s) which is/are coupled to the car 10, or the data may be obtained from sensor(s) or device(s) which is/are coupled to the movement means 12 or the movement generation unit 12, such as comprising a motor, which may be a rotary or a linear electric motor, or based on hydraulics, for instance. Alternatively or in addition, the data may be obtained from sensor(s) or device(s) which is/are coupled to a movement controlling means 14 or a motion control unit 14, such as comprising a frequency converter or an inverter for controlling the operation of an electric motor, or other motion control unit 14, such as controlling hydraulics of a hydraulic elevator. In various embodiments, the monitoring unit 22 may, preferably, be arranged to the site/location of the elevator 200 and in connection with one or several sensor(s) or device(s) of the elevator 200 to receive the data. Optionally, the elevator monitoring system 20 may comprise a computing unit 24 or system 24, such as being communicatively connected with the monitoring unit 22. Such computing unit 24 may be external, such as communicated over the internet, for example, being a cloud computing system, or internal, that is being a local computing system running a database, for instance.

There may be, optionally, a braking arrangement 46 in the elevator 200.

FIG. 2B illustrates schematically elevator monitoring system 20 according to an embodiment. In the system 20 of FIG. 2B, the monitoring unit 22, or optionally more than one, such as two, monitoring units 22, are arranged to, such as coupled to, one of the components of the elevator 200, such as to the elevator car 10 or the movement means 12 or a movement generation unit 12, or to the movement controlling means or the motion control unit. Especially in the case of having the monitoring unit 22 being arranged to the elevator car 10, the sensor(s), if any, of the monitoring unit 22 may be arranged to measure the data related to movement and/or position of the elevator car 10. The monitoring unit 22 may thus comprise one or several of the following: an accelerometer, an air pressure sensor, a speed sensor, a velocity sensor, an absolute or relative position measurement sensor, a magnetometer, an optical sensor, such as a camera, a magnetic tape reader, a laser distance measurement, a radar, a sound based distance measurement device, such as based on ultrasound, an incremental encoder, such as a low pulse incremental encoder, or parts thereof. Thus, even if there is originally no sensor data available from the elevator car 10, the monitoring unit 22 can determine, such as measure, movement and/or position related data by itself when being arranged to move with the elevator car 10. Details of the computing unit 24 or system 24 as described in connection with FIG. 2A apply also to FIG. 2B. Furthermore, there may optionally be a master controller 26 for operating one or several monitoring unit(s) 22 of the elevator monitoring system 20. The master controller 26 may then be arranged to communicate outside the elevator 200, such as with the computing unit 24 or system 24.

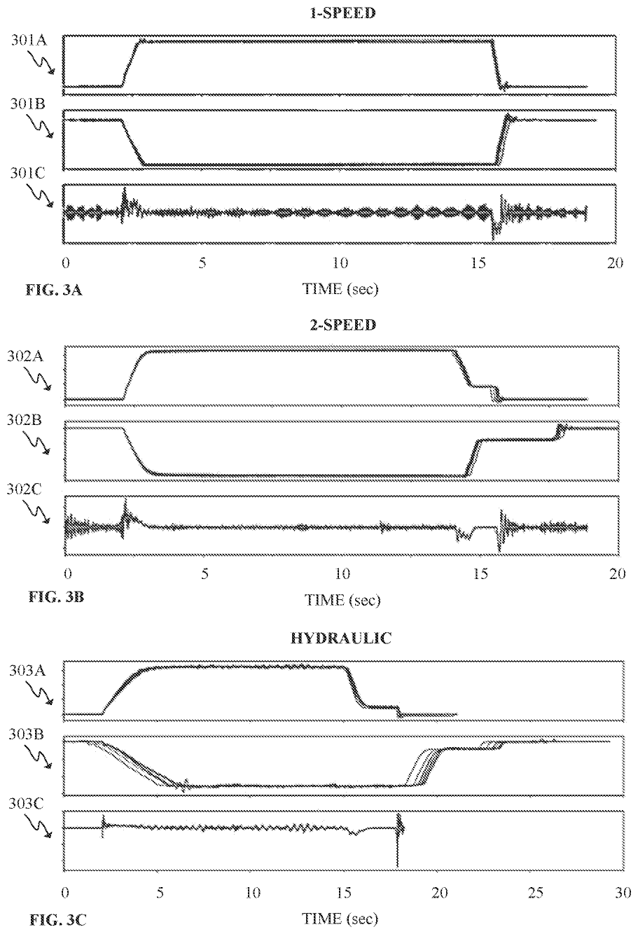

FIGS. 3A-3D illustrates graphs related to operation of elevators with different types in accordance with some embodiments. The types are, as marked in FIGS. 3A-3D, direct online type having one speed (1-SPEED), direct online type having two speeds (2-SPEED), hydraulic elevator, and variable speed drive elevator type, respectively.

The differences between the different elevator types can be seen in FIG. 3A-3D. They contain multiple examples of speeds/velocities from rides going up and down, that is at 301A-304A in upwards direction and 301B-304B in downwards direction, in addition to an example of an acceleration curve, that is at 301C-304C, for one of the rides. The velocity curves 301A-304A, 301B-304B are from rides between same floors.

Regarding the steady speed area, in FIG. 3A-3D, the steady speed area is visible between the acceleration phase and the deceleration phase. In FIGS. 3B and 3C, there are two steady speed areas, however, only one or both of them may be utilized for the determination of the type of elevator.

As can be seen in FIG. 3A, at 301C around time instance of 2.5 seconds, there is a large jerk visible in the acceleration curve. This is characteristic for the one speed direct online elevators, and can thus be utilized in accordance with various embodiments to classify the elevator correctly as a one speed direct online type of an elevator.

FIG. 3B shows, at 302A and 302B, that the deceleration phase has clearly two distinct constant speed sub-phases. This is characteristic for the two speed direct online elevators, and can thus be utilized in accordance with various embodiments to classify the elevator correctly as a two speed direct online type of an elevator.

Furthermore, regarding elevators with open-loop scalar control, such as is the case in FIGS. 3A and 3B, the speed at the steady speed area has large variation or ripple which is due the supply frequency and the elevator car load (e.g., due to the slip). This means that there may be differences in the variations between consecutive rides since the supply frequency and/or the elevator car load may change between the rides. This information may be extracted from the data obtained, and utilized for determining the elevator type.

FIG. 3C shows, at 303A, that there is large ripple in the speed/velocity curve when the elevator car 10 is being moved upwards. This is characteristic for the hydraulic elevators, and can thus be utilized in accordance with various embodiments to classify the elevator correctly as a hydraulic type of an elevator.

Finally, FIG. 3D shows, at 304A and 304B, that the speed/velocity is well-controlled and it is further visible at 304C that the jerk in the beginning the acceleration phase is small. This is characteristic for the variable speed drive elevators, and can thus be utilized in accordance with various embodiments to classify the elevator correctly as a variable speed drive type of an elevator. Furthermore, the speed variation at the steady speed area is small in these types of elevators.

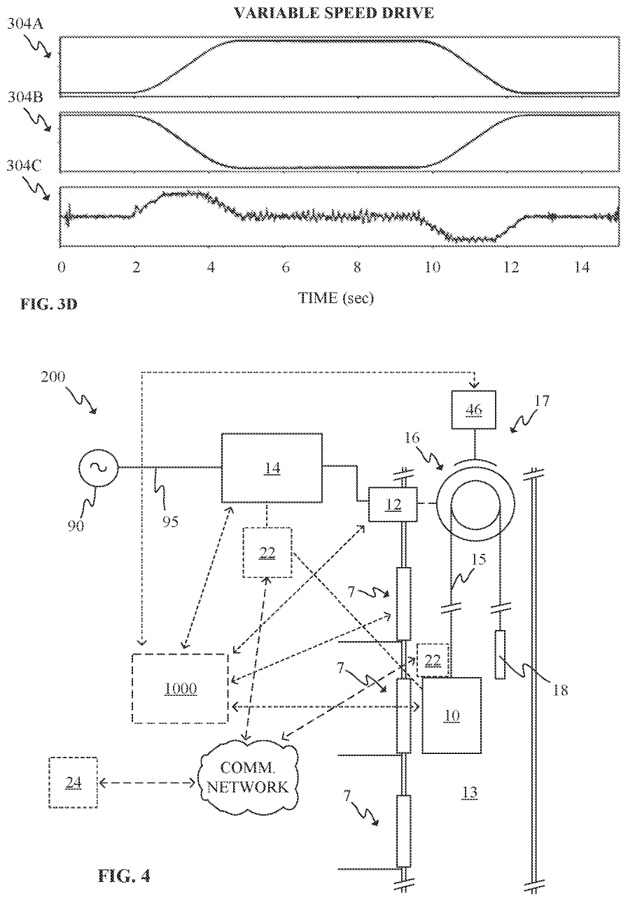

FIG. 4 illustrates an elevator 200 according to an embodiment. The elevator 200 comprises an elevator car 10 movable in an elevator shaft 13. The elevator 200 may, preferably, comprise movement means 12 or a movement generation unit 12, such as comprising a motor, for providing the movement of the elevator car 10, and movement controlling means 14 or a motion control unit 14, such as comprising a frequency converter, for controlling the movement. The movement means 12 or a movement generation unit 12, such as an electric motor and/or hydraulics, are, preferably, arranged to cause moving of the elevator car 10. There may also be a braking arrangement 46 arranged to provide braking with respect to movement of the elevator car 10.

There may be a sensor or sensors in connection with at least one of the following: the elevator car 10, the movement means 12 or the movement generation unit 12, and the movement controlling means 14 or the motion control unit 14. There may also be other sensors in the elevator 200 for providing information about the movement and/or position of the elevator car 10, as well as other operational parameters. The sensor(s) in connection with the elevator motor 10 may be a motor encoder. The sensor may be a position, speed, and/or acceleration/deceleration sensor for generating position, speed, and/or acceleration/deceleration measurement data. Such sensor may, alternatively or in addition, be in connection with the traction sheave 16 or the like of the elevator 200. In FIG. 4, the sensor(s) may be arranged to the elevator car 10 for determining position, speed, and/or acceleration/deceleration of the elevator car 10. The sensor(s), on the other hand, may be at least partly arranged to the elevator shaft 13. The sensor may refer to absolute positioning means, in which case the sensor may extend in the elevator shaft 13, continuously or in discrete steps, for providing absolute position information of the elevator car 10. Thus, as can be understood, the position, speed, and/or acceleration/deceleration measurement data may be generated by a combination of different sensors, such as having one sensor, or part thereof, on the elevator car 10 and another one fixed to the elevator shaft 13 and arranged to co-act with the one in the elevator car 10. Still further, the sensor(s) may be a voltage or a current sensor(s) for determining voltage or current of the movement means 12 or the movement generation unit 12 or the movement controlling means 14 or the motion control unit 14.

Alternatively or in addition, such sensor(s) as described in the above, may be arranged to the monitoring unit(s) 22 as described in connection with FIG. 2B hereinbefore.

In some embodiments, the elevator car 10 may thus be mechanically coupled to the movement means 12 or the movement generation unit 12, such as to the elevator motor, for example, by a hoisting rope 15. The operation of the elevator motor 12 may be controlled by an electric power converter, such as a frequency converter or an inverter. The hoisting rope 15 may comprise, for example, steel or carbon fibers. The term ‘hoisting rope’ does not limit the form of the element anyhow. For example, the hoisting rope 15 may be implemented as a rope or a belt.

The elevator 200 may comprise an elevator controlling unit 1000 for controlling the operation of the elevator 100. The elevator controlling unit 1000 may be a separate device or may be comprised in the other components of the elevator 100 such as in or as a part of the movement controlling means 14 or the motion control unit 14. The elevator controlling unit 1000 may also be implemented in a distributed manner so that, for example, one portion of the elevator controlling unit 1000 may be comprised in the movement controlling means 14 or the motion control unit 14, and another portion in the elevator car 10. The elevator controlling unit 1000 may also be arranged in distributed manner at more than two locations or in more than two devices.

The elevator 200 may comprise an elevator brake 17, preferably, an electromechanical elevator brake as a part of the braking arrangement 46, for braking and/or holding the elevator car 10 to its position, such as at a landing 7. The brake(s) 17 may operate such that the magnetization of the coils of the brake(s) 17 deactivates the brake(s) 17 by force applied via magnetic field. A brake controlling unit may be integrated into the brake 17 or may be a separate brake controller device. The brake 17 may be connected to the elevator controlling unit 1000.

Other elements shown in FIG. 4, which may or may not be part of some embodiments, are a main electrical power supply 90 such as a three- or single-phase electrical power grid, an electrical connection 95 thereto of the elevator 100. The elevator car 10 may operate in an elevator shaft or hoistway 13 serving landing floors 7. There may or may not be a counterweight 18 utilized in some embodiments.

The monitoring unit 22 and/or the elevator controlling unit 1000 may comprise external units connected to a communication interface of the monitoring unit 22 and/or the elevator controlling unit 1000. External unit may comprise wireless connection or a connection by a wired manner. The communication interface provides interface for communication with external units such as the elevator car 10, the elevator motor 10, the doors of the landing floors 7, or the electric power converter 14 to the processing unit 22. There may also be connecting to the external system, such as a laptop or a handheld device. There may also be a connection to a database of the elevator 100 or an external database including information used in controlling the operation of the elevator motor 12.

The processing unit 22 may comprise one or more processors 504, one or more memories 506 being volatile or non-volatile for storing portions of computer program code 507A-507N and any data values and possibly one or more user interface units 510. The mentioned elements may be communicatively coupled to each other with e.g. an internal bus.

The processor 504 of the processing unit 22 is at least configured to implement at least some method steps as described. The implementation of the method may be achieved by arranging the processor 504 to execute at least some portion of computer program code 507A-507N stored in the memory 506 causing the processor 504, and thus the processing unit 22, to implement one or more method steps as described. The processor 504 is thus arranged to access the memory 506 and retrieve and store any information therefrom and thereto. For sake of clarity, the processor 504 herein refers to any unit suitable for processing information and control the operation of the processing unit 22, among other tasks. The operations may also be implemented with a microcontroller solution with embedded software. Similarly, the memory 506 is not limited to a certain type of memory only, but any memory type suitable for storing the described pieces of information may be applied in the context of the present invention.

The specific examples provided in the description given above should not be construed as limiting the applicability and/or the interpretation of the appended claims. Lists and groups of examples provided in the description given above are not exhaustive unless otherwise explicitly stated.

1. A method for determining a type of elevator, wherein the method comprises:
obtaining data related to movement and/or position of a component of a hoisting system of the elevator system;
determining from the data at least one characteristic value related to the movement and/or position; and
determining the type based on pre-defined elevator types of an elevator type classification and the characteristic value.

2. The method of claim 1, comprising adapting at least one parameter of an elevator monitoring system of the elevator based on the determined type of elevator.

3. The method of claim 2, wherein the determination of the type is based on comparison of information in the obtained data related to an event to pre-defined information in the elevator type classification for the same event.

4. The method of claim 2, comprising:
receiving further data related to movement and/or position of the component; and
comparing information obtained from the further data to at least one criterion defined based on the adapted at least one parameter so as to monitor a condition and/or performance of the elevator.

5. The method of claim 2, comprising generating, by the elevator monitoring system, an alert related to a reduction in the condition and/or performance determined based on the comparison.

6. The method of claim 1, wherein the movement and/or position includes at least one selected from the group consisting of: absolute or relative position, speed, velocity, acceleration, deceleration, jerk.

7. The method of claim 1, wherein the obtaining comprises determining the data by at least one selected from the group consisting of: an accelerometer, an air pressure sensor, a speed sensor, a velocity sensor, an absolute or relative position measurement sensor, a magnetometer, an optical sensor, a magnetic tape reader, a laser distance measurement, a radar, a sound based distance measurement device, an incremental encoder.

8. The method of claim 1, wherein the elevator type classification includes reference characteristic value or values for the at least one characteristic value in relation to the pre-defined elevator types.

9. The method of claim 1, wherein the predefined elevator types include at least two selected from the group consisting of: roped elevator, hydraulic elevator, linear motor elevator.

10. The method of claim 1, wherein the predefined elevator types are defined by at least two elevator characteristics.

11. The method of claim 10, wherein the at least two elevator characteristics include movement means and movement controlling means.

12. The method of claim 11, wherein the movement means include at least roped type and hydraulic type.

13. The method of claim 11, wherein the movement controlling means include at least one selected from variable speed drive type, direct online type, and hydraulic type.

14. The method of claim 11, wherein the movement controlling means include sub-types as defined in the following:
the variable speed drive sub-types being scalar control, and vector control, such as field-oriented control or direct torque control; and
the direct online sub-types being one-speed or two-speed.

15. The method of claim 1, wherein the elevator type classification includes reference characteristic value or values for at least one selected from the group consisting of:
duration and/or amplitude of jerk,
duration and/or amplitude of acceleration/deceleration,
duration and/or amplitude of velocity in steady speed area,
speed variation in the steady speed area between consecutive rides between same landings and direction,
number and shape of deceleration phases,
similarity of drive curves in opposite directions,
elevator car vibrations during ride phases, or
values calculated from the Fourier spectrum of acceleration curve.

16. The method of claim 1, wherein at least one characteristic value relates to at least one selected from the group consisting of:
duration and/or amplitude of jerk,
duration and/or amplitude of acceleration/deceleration,
duration and/or amplitude of velocity in steady speed area,
speed variation in the steady speed area between consecutive rides between same landings and direction,
number and shape of deceleration phases,
similarity of drive curves in opposite directions,
elevator car vibrations during ride phases, or
values calculated from the Fourier spectrum of acceleration curve.

17. The method of claim 1, wherein the component of the hoisting system is one of the following: the elevator car, a hoisting rope, a traction sheave or pulley, an elevator motor.

18. An elevator monitoring system comprising a processing unit and a memory, wherein the system is configured to execute steps of the method in claim 1.

19. The elevator monitoring system of claim 18, comprising or being connected to at least one selected from the group consisting of: an accelerometer, an air pressure sensor, a speed sensor, a velocity sensor, an absolute or relative position measurement sensor, a magnetometer, an optical sensor, a magnetic tape reader, a laser distance measurement, a radar, a sound based distance measurement device, an incremental encoder.

20. An elevator comprising:
an elevator car movable in an elevator shaft;
movement means or a movement generation unit, for providing the movement of the elevator car; and
movement controlling means or a motion control unit, for controlling the movement,
wherein the elevator comprises the elevator monitoring system of claim 1.
